(19) United States
(12) Patent Application Publication
(10) Pub. No.: US 2015/0084584 A1
(43) Pub. Date: Mar. 26, 2015

(54) WIRELESS CHARGING CONTROL FOR MULTIPLE ELECTRONIC DEVICES

(71) Applicant: Motorola Solutions, Inc., Schaumburg, IL (US)

(72) Inventors: DEBORAH J. MONKS, Palatine, IL (US); RANJAN CHATTERJEE, Kildeer, IL (US); HUGHES CHENG, TAIPEI (TW); WEI LIN, Lake Zurich, IL (US); MICHAEL A. TRAMONTANO, Franklin, MA (US)

(73) Assignee: Motorola Solutions, Inc., Schaumburg, IL (US)

(21) Appl. No.: 14/038,172

(22) Filed: Sep. 26, 2013

(51) Int. Cl. H02J 7/02; H02J 7/00

(52) U.S. Cl. CPC H02J 7/025; H02J 7/0027
USPC 320/108; 320/137; 320/162

(57) ABSTRACT

A method and system for wirelessly charging a plurality of electronic devices includes a charging station operable to wirelessly charge the plurality of electronic devices. A server is operable to assign a charging priority to each electronic device based on usage information. A controller is coupled to the charging station and including a transceiver for communicative coupling to the server. The controller is operable to receive the charging priority of each electronic device from the server via the transceiver and wirelessly charge the plurality of electronic devices in accordance with the charging priority of each electronic device.

### BACKGROUND

Mobile communication devices continue to gain popularity in public safety, emergency, and government communications. For example, there are four million government vehicles in use today in the United States alone, and multiple users of these vehicles can each have at least one portable communication device. These devices can include land mobile radios, cell phones, tablets, laptops, and new smart accessories such as glasses and wrist-worn devices. A common requirement for these vehicle-based workers is to have their portable device batteries last an entire shift. However, under constant use few of these devices can retain a charge this long when under constant use. Therefore, a solution is needed for charging these devices.

Typically, a vehicle will include at least one twelve-volt direct-current electrical outlet that can be used to charge one electronic device as long as the proper wired adapted for that particular device is available. However, this solution is insufficient where more than one device needs to be charged in the vehicle, or if the proper wired adapter for each particular device is not available. A solution to these problems is to use a common charger for radios, cell phones, and mobile computers, which has the advantage of space and cost savings.

However, a worker's device needs to be usable for a full shift, and the worker cannot afford to leave their communication device on a charger when they leave their vehicles. One solution to this is to use larger battery sizes for each device or supply extra charged batteries that can be exchanged during a workers shift. However, this solution is cumbersome for workers since; they may not want to carry the added weight of a large battery, they prefer not to have to exchange batteries mid-shift, spare charged batteries may not be available, or the worker may not even know that their device requires charging. In addition, some devices are worn on the workers clothing or belts, and these users do not want to remove them for charging or are even discouraged from removal of the devices. Further, workers can be focused on their activities and may not know when a battery needs recharging, particularly when each device has different charging intervals, which also varies based on usage. In addition, workers prefer smaller/lighter devices, so smaller batteries are desirable.

A solution to the above problems can include a wireless charge station for a vehicle or a wired charge station with multiple adapters, in order to charge multiple devices at the same time. However, where there are too many devices to charge, the amount of available charging current may be insufficient to charge all the devices appropriately or in a timely manner.

Accordingly, there is a need for a technique to eliminating the aforementioned issues. Furthermore, other desirable features and characteristics of the present invention will become apparent from the subsequent detailed description and the appended claims, taken in conjunction with the accompanying drawings and the foregoing background.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with some embodiments of the present invention.

FIG. 2 is a simplified flow diagram illustrating a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, an improved technique is described to control the charging of multiple electronic devices in a vehicle, as will be detailed below. It is envisioned that this charging is accomplished by a common wireless charging station operable to charge many different electronic devices given an appropriate wireless charging interface for each device to be charged configured to appropriately capture charge energy from the charging station. The wireless nature of the charging can allow devices to be in use while they are being charged. The present invention includes a system and method for charging multiple mobile communication devices in accordance to a charging priority that is determined dynamically or may be predetermined by a server. The devices with the highest priority will be fully charged first. In one embodiment, one or more lower priority devices may receive a minimum charge to allow operation, before the devices with the highest priorities are fully charged.

The device to be charged can include a wide variety of government, enterprise, business, and consumer electronic platforms such as land mobile radios, cellular radio telephones, mobile stations, mobile units, mobile nodes, user equipment, subscriber equipment, subscriber stations, mobile computers, access terminals, remote terminals, terminal equipment, smart phones, personal computers, and personal digital assistants, and the like, all referred to herein as an electronic device. Each device comprises a processor that can be further coupled to a keypad, a speaker, a microphone, audio circuitry, a display, a signal processor, a wireless charging interface, a battery, and other features, as are known in the art and therefore not shown or described in detail for the sake of brevity.

Various entities are adapted to support the inventive concepts of the embodiments of the present invention. Those skilled in the art will recognize that the drawings herein do not depict all of the equipment necessary for system to operate but only those system components and logical entities particularly relevant to the description of embodiments herein. For example, routers, controllers, servers, switches, access points/ports, and wireless clients can all includes separate communication interfaces, transceivers, memories, and the like, all under control of a processor. In general, components such as processors, transceivers, memories, batteries, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, and/or expressed using messaging logic flow diagrams.

Thus, given an algorithm, a logic flow, a messaging/signaling flow, and/or a protocol specification, those skilled in the art are aware of the many design and development techniques available to implement one or more processors that perform the given logic. Therefore, the entities shown represent a system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the control aspects of the present invention may be implemented in any of the devices listed above or distributed across such components.

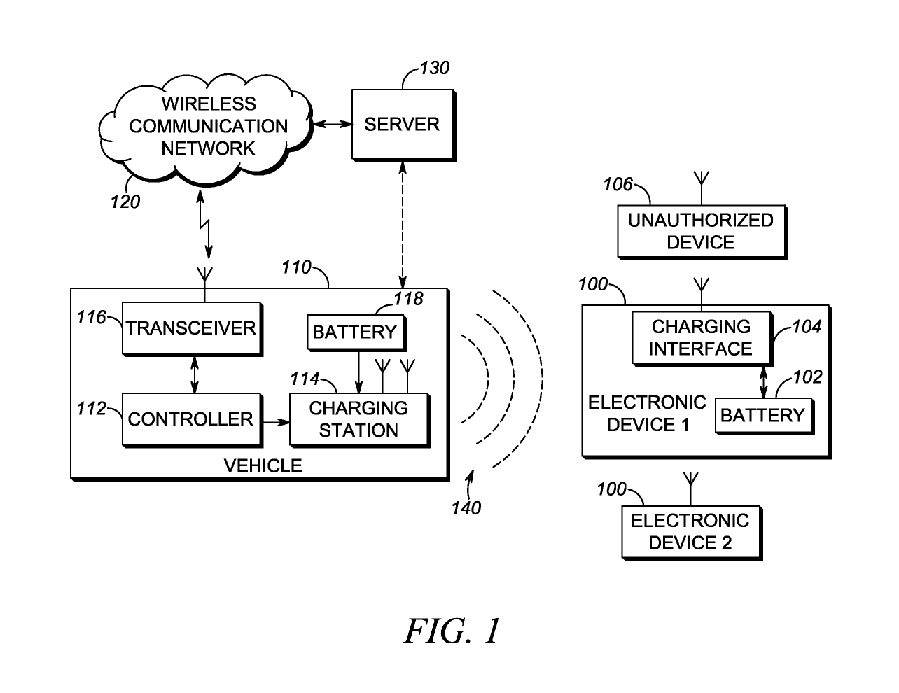

FIG. 1 shows a simplified block diagram of a system for wirelessly charging a plurality of electronic devices 100 in a vehicle 110, in accordance with some embodiments of the present invention. Although, the present invention is described in terms of a vehicular environment, such as a police car or fire truck for example, it should be recognized that the present invention is applicable to any environment where a charging station may be located including an office, warehouse, factory, business, local command center, staging area, etc. As shown, the vehicle 110 is equipped with a communication system including controller 112 and a transceiver 116 operable to communicate with a server, that can be either a dedicated local server to the vehicle or a remote centralized or Cloud-based server 130 (i.e. dispatcher) using a wireless communication network 120 that can be any wired or wireless communication network including a public cellular network, a secure land mobile network, and private enterprise network, or Cloud network for example.

The vehicle also includes a wireless charging station 114 or charging transmitter under control of the controller 112 and being powered by a power source such as the vehicle battery 118, alternator, solar cell, fuel cell, external connection to an electric utility grid, and the like. The charging station is operable to wirelessly charge the plurality of electronic devices 100, such as through a contactless magnetic resonance charging mechanism as is known in the art for example, wherein the charging station is coupled in a near field to a charging interface 104 (one shown) of each electronic device 100 operable to charge the battery 102 (one shown) of each electronic device 100 when it is in range of the charging station 114, either in or near the vehicle. The charging station can have multiple antennas, configured in a phased array for example, used to steer a charging energy beam to a particular device having a particular location, distance and/or orientation with respect to the charging station. It should be recognized that the electronic device could also connect to the charging station 114 via a wired connection or other wireless system such as a magnetic induction charger given the appropriate interface.

Ordinarily, all devices placed within a charging field 140 of a charging station, and having the appropriate charging interface, will be able to be charged on an equal basis. However, in the present invention each electronic device is wirelessly charged in accordance to a charging priority assigned to that device. In particular, the server 130 is operable to assign a charging priority to each electronic device based on various parameters, as will be detailed below, and the charging station will charge these devices deferentially based on their charging priority. The server may be located in the vehicle or centrally located or in the Cloud. If located in the vehicle the server still communicates with other applications to determine priority.

Specifically, the controller 112 can scan for nearby electronic devices 100, or the electronic devices can scan for nearby vehicles 110 having charging stations 114 within charging range. In either case, the nearby electronic devices 100 will be registered with a local controller 112. Registration involves the exchange of information that can include at least one or more of; electronic device identity, security credentials for authorization, and a service profile of each electronic device. For example, the service profile can include the current battery drain, currently running applications, current work assignments, and communication networks presently in use (to project battery drain), and the ability to transfer power to another device.

This information is then transmitted by the local controller 112 to the server 130 using the transceiver 116 communicating over the wireless communication network 120 or simply provided to the server if local to the vehicle. Nowadays, most police vehicles connect back to a central server through a wireless data channel. This central server usually has more computing power and can store much more information, including vehicle location, current and next task assignment for officers in a specific vehicle, a crime database, etc. Also, the central server is a better control unit to authorize each device. Therefore, if there is no local server, the present invention utilizes a server to determine charging priority for wireless charging of electronic devices.

The server can assign a charging priority to each electronic device based on its information and its operational context. Using the security credentials in the information, the server can first check that the electronic device 100 is authorized to be charged by the vehicle. If the device is unauthorized 106, the server can generate a warning or alarm to prevent access to the charging station for that device 106. This can be a simple message on a user interface in the vehicle, at a remote administrator terminal, sent to authorized entities, or it can be instructions for the controller 112 to prevent charging of that device 106.

If the device is authorized, the server can then establish an operational context of the device, using its service profile and/or a variety of other parameters. For example, the server can aggregate information related to the vehicle, devices and people who are in or near the vehicle. In particular, there may be a business rule not to charge devices if a person is present or to charge at a different energy level if a person is present. Further, devices not associated with a known person assigned to the vehicle (e.g. a suspect in custody) would not be charged, as these devices would fail the authentication procedure. In addition, the person with whom a device is associated (or their role in Computer Aided Dispatch (CAD)) can be used in determining the charging priority.

A software program in the server can make intelligent charging decisions on which device should be charged, at what time, and for how long, in real time. In particular, the charging software program contains business rules and interfaces to mobile device management applications external to the charging application in the controller (e.g. CAD, 311 information, Automatic Vehicle Location, information portal, context detection applications, vehicle computer mobile applications, location service, etc.) to obtain and calculate dynamic device charging priority parameters. For example, CAD can be used to obtain the location and type of next call for service, which is used to calculate the available time to charge and the amount of charge needed for the next use or task. In addition, those electronic devices using more important software applications are assigned a higher charging priority than electronic devices being using less important software applications. Also, those electronic devices being used by higher authority users are assigned a higher charging priority than electronic devices being used by lower authority users. Also, those electronic devices having an estimated future task that is more important are assigned a higher charging priority than those electronic devices having an estimated future task that is less important. Also, electronic devices having a lower charge level are assigned a higher charging priority than those electronic devices having a higher charge level. Also, electronic devices having a more important operational location are assigned a higher charging priority than those electronic devices having a less important operational location.

Examples of determined charge priority based on operational context can include: a) the radio with the lowest battery level is given a priority to be charged first, b) a radio that has enough power to handle the next incident task is given a lower charge priority, c) a worker's headset battery is below the level needed for the worker to handle the next incident task and is given a higher charge priority, d) when users leave the vehicle, all the devices left in the vehicle are charged in priority order, with higher power levels than when users are present, and e) limiting the charging of each electronic device to a charge level sufficient for each electronic device to accomplish an estimated future task within a defined time period.

In practice, determining charging priority can be based on the following parameters; device type priority (e.g. a Bluetooth™ headset accessory or a personal cellular phone will have a lower priority than a police radio), remaining battery life and one or more of the following: most recent/prior incident type and next incident type or task assigned to the officer, estimated time until next use, length of next use, remaining shift time, authority level of a user, the device being worn on person versus being away from person, number of devices to be charged, estimated time available to charge, user context (e.g. en route to a major incident), estimated use time at next location (e.g. next call for service is a domestic disturbance which can last one hour), which devices are enabled to charge other devices, class of device that should not be charged if worn on the person (e.g. earpiece), current device user role/priority, call for a service location, device priority by incident type, etc. It is envisioned that the charging priority is determined by the server charging software program. However, the charging priority also can be determined by an end user or dispatcher.

Charging priority can also be changed to maximizing officer safety by turning charging off when not needed, and focusing on where charging is needed. For example, it is desirable to always have a charged device for communications so that an officer can ask for help, obtain intelligence about persons dealing with, and be located when needed. This is accomplished by calculating, using CAD and other resources, the amount of charge needed to handle the next incident depending on the device type being carried. In another example, it is desirable to only emitting power for charging a device when it is needed, and optionally in the direction needed, in order to minimize power going where it is not needed. This is accomplished by not initiating charging if it is not needed, and by directing the energy to the location of the device to be charged and minimizing energy directed elsewhere.

A message including the charging priority for each authorized electronic device is then sent back to the controller 112 by the server 130. The local controller then receives the message from the server. The message can also include authorization to charge the electronic device or notification of an unauthorized device that is not to be charged. The message can further include instructions as to charging sequence, an amount of charging time for each device, a need to move a device to a particular location with respect to the vehicle, etc. The message can also include directions for the local controller 112 to provide instructions to particular devices, e.g. send instructions to a vehicle device and not a handheld device.

The controller then directs the charging station to proceed with wireless charging of the plurality of authorized electronic devices in accordance with the charging priority of each electronic device. This can include the controller scanning to find the device with highest priority, and can also include adapting the operation of the charging station to charge higher priority electronic devices before lower priority electronic devices. Also, this step can include limiting charging of each electronic device to a charge level sufficient for each electronic device to accomplish a task within a defined time period. Further, this step can include adjusting the power output in the charging station antenna(s) and transmitting maximum power toward a location of the highest priority device (which can be determined by the charging station and the device communicating with each other to exchange information to maximize the power transfer), and/or away from lower priority or even unauthorized devices. In addition, the controller could inform lower priority devices to “turn off” their charging function. How a device is charged can also be changed in response to dynamic parameters. For example, a dynamic parameter may be an officer's location with respect to the charging station, where an officer inside a vehicle can be provided a higher charge energy than an officer located just outside of the vehicle.

Optionally, the controller can include indicating a charging status of each electronic device, either locally or to the server. This can be used to track a police officer's device battery usage. For example, if an officer leaves a vehicle without enough battery power in their mobile device to complete their task or shift, a timer based on an estimate of remaining battery power can be started. Upon expiry of the timer an alarm can be communicated to the officer (e.g. via a text message to another one of their communication devices, if available) directing that the device be charged by placing it in the charging area. Such information can also help dispatch to track officer's status. For example, a charging application can notify a communication application, such as the information portal or a dispatch application, that a user has left a device in the car or that a user device has left the vehicle with a low battery. In addition, the server can inform a communication service attempt to contact a device that the identified electronic device is being charged and is not in service.

In addition, the controller can provide charging information or directions to a user. For example, the controller can notify a device user to move a device to be charge to a specific area, i.e. an area where the charging energy level is higher or notify the user if they leave the vehicle without a device. In another example the controller can generate a signal or alarm to the user or dispatcher if one or more business rules are violated.

In actual operation, differential charging by priority can be accomplished in many different ways by a wireless charging station. Logistically, if there are too many devices to charge at one charging station, then the controller can scan for those devices that have the highest priority, and inform the user of those devices having a lower priority to remove their devices to a different charging station, or wait for the higher priority devices to be fully charged first. Informing can be done by sending a text or call to a user of the lower priority device, or by direct instruction to lower priority devices to disconnect their charging interface.

In the case where the charging station has the capacity for both the higher priority and lower priority devices that are present, the present invention can cause the higher priority devices to charge for a longer time or at a higher power than the lower priority devices. For example, higher priority devices can be directed to have their charging interface use full current while lower priority devices can be directed to have their charging interface use only a trickle current. Alternatively or in addition, higher priority devices can be directed to have their charging interface connect to the charging station for a longer period than lower priority devices.

Charging of higher priority devices can be done at the same time as lower priority devices, where lower priority devices can be charged to a predefined threshold level, and maintained there while the higher priority device fully charges. The controller can direct the charging interface of the lower priority devices to interrupt charging or maintain a trickle charge when the lower priority device reaches the threshold level. Charging of the lower priority devices can continue when the higher priority device becomes fully charged. It is envisioned that there can be different thresholds for different device types and priorities. It may also be that the charging station is able to steer or direct its charging field in a particular orientation. In this case, power can be directed more towards those devices having a higher priority in a known location. In this way, the controller need not communicate with the device to change its charging interface connection.

Therefore, in practice, the present invention uses a server to determine a charging priority of electronic devices in or near a vehicle having a charging station. The server uses various usage information, obtained from the vehicle controller or by itself, to determine the charging priority. This usage information includes any one or more of: a device user role/priority, a device type/identity, a device authority, a user's authority/security credentials, whether a device has the proper charging interface for that vehicle's charging station, a business rule, a service profile of the device, and an operational context of the device. Service profile can include one or more of: current battery drain, current charge level, currently running applications, communication networks in use, and the ability to transfer power to another device. Operational context can include one or more of: vehicle location, crime database for that location, current task (location/type) for users/officers, next task (location/type/predicted duration) for users/officers to perform, and time until shift change. Once the charging priority for a device has been determined the server sends this charging priority, and optionally a charging profile (i.e. charging power level and duration to be used), to the vehicle local controller.

The vehicle local controller then uses the charging priority, and optional charging profile, to charge the devices in or near to its charging station. The local controller can provide a charging profile for a device (if one has not been provided by the server) to modify the charging profile based on local parameters. These modifications can include one of more of: using a different charging profile (power level and duration) for different priority devices, direct the charging beam to higher priority devices, hold lower priority devices at threshold charge level, change charging profiles if people are present in/near the vehicle, change charging profile dependent on device location with respect to vehicle, and directing a lower priority device to turn off its charging function.

The vehicle local controller can also provide messaging to local or remote users relating to charging of a device. This messaging can include one or more of: a device/user is unauthorized to have their device charged, a device has an improper charging interface, instructions for a local user for a charging sequence for multiple devices, a need to move a device location with respect to the charging station, indicate charging status/battery usage, tell a user/dispatcher that a device needs charging, a violation of business rule, and indicating that lower priority devices need to be removed or to wait. In any of the above, different messaging can be sent to different devices, locally or remotely.

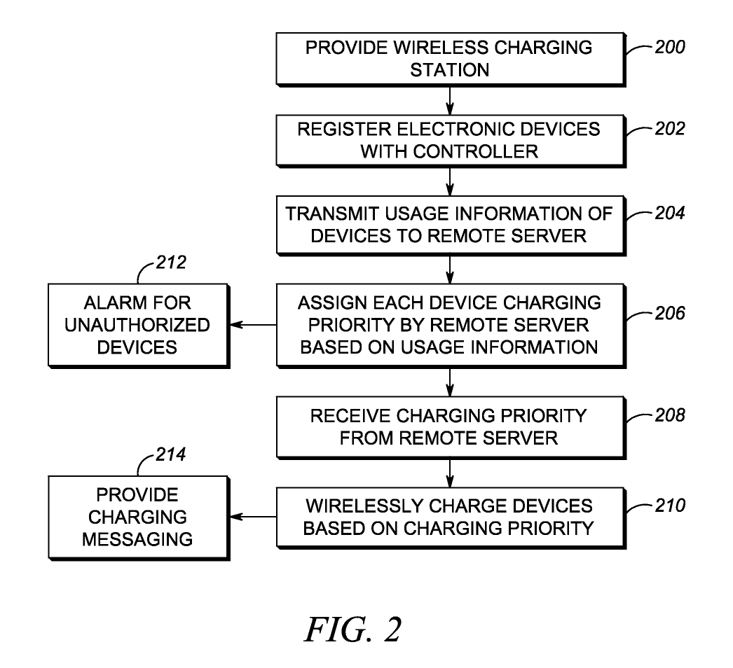

FIG. 2 shows a flowchart of a method for wirelessly charging a plurality of electronic devices, according to some embodiments of the present invention. A first step 200 includes providing a charging station in a vehicle operable to wirelessly charge the plurality of electronic devices.

A next step 202 includes registering with the local controller at least one of the group of device identity, security credentials, and a service profile of each electronic device within charging range of the charging station.

A next step 204 includes transmitting usage information at least one of the group of device identity, security credentials, a service profile, and an operational context of each electronic device by the local controller to the server.

A next step 206 includes assigning a charging priority to each electronic device based by a server based on the usage information. If a device is not authorized to be charged, an alert can be generated 212.

A next step 208 includes receiving the charging priority for each electronic device from the server. This can also include obtaining authorization to charge the electronic device from the server based on the security credentials and service profile of the electronic device. If an unauthorized device is attempting to use the charging station, the controller or server can generate an appropriate alarm.

A next step 210 includes wirelessly charging the plurality of electronic devices in accordance with the charging priority of each electronic device. This step can include modifying a charging profile of an electronic device based on local parameters. This can include adapting the operation of the charging station to charge higher priority electronic devices before lower priority electronic devices. Also, this can include limiting charging of each electronic device to a charge level sufficient for each electronic device to accomplish a task within a defined time period.

Optionally, a next step 214 can include providing messaging to local or remote users regarding charging of each electronic device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors or processing devices such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc Read Only Memory, an optical storage device, a magnetic storage device, a Read Only Memory, a Programmable Read Only Memory, an Erasable Programmable Read Only Memory, an Electrically Erasable Programmable Read Only Memory, and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for wirelessly charging a plurality of electronic devices, comprising:
a charging station operable to wirelessly charge the plurality of electronic devices;
a server operable to assign a charging priority to each electronic device based on usage information of each electronic device; and
a controller coupled to the charging station and including a transceiver for communicative coupling to the server, the controller operable to receive the charging priority of each electronic device from the server via the transceiver and wirelessly charge the plurality of electronic devices in accordance with the charging priority of each electronic device.

2. The system of claim 1, wherein electronic devices using more important software applications are assigned a higher charging priority than electronic devices being using less important software applications.

3. The system of claim 1, wherein electronic devices being used by higher authority users are assigned a higher charging priority than electronic devices being used by lower authority users.

4. The system of claim 1, wherein electronic devices having an estimated future task that is more important are assigned a higher charging priority than those electronic devices having an estimated future task that is less important.

5. The system of claim 4, wherein the controller is further operable to limit the charging of each electronic device to a charge level sufficient for each electronic device to accomplish its estimated future task within a defined time period.

6. The system of claim 1, wherein the controller is further operable to;
have each electronic device within charging range register its security credentials and service profile,
transmit the security credentials and service profile to the server, and
obtain authorization to charge the electronic device from the server based on the security credentials and service profile of the electronic device.

7. The system of claim 6, wherein the controller is further operable to adapt the charging station operation to charge higher priority electronic devices before lower priority electronic devices.

8. The system of claim 6, wherein the controller is further operable to generate an alarm if an unauthorized electronic device attempts to use the charging station.

9. The system of claim 6, wherein the server is further operable to inform a communication service that an identified electronic device is being charged and is not in service.

10. The system of claim 6, wherein the controller is further operable to inform the server about a charging status of an identified electronic device.

11. The system of claim 1, wherein electronic devices having a lower charge level are assigned a higher charging priority than those electronic devices having a higher charge level.

12. The system of claim 1, wherein electronic devices having a more important operational location are assigned a higher charging priority than those electronic devices having a less important operational location.

13. The system of claim 1, wherein charging priority is based on device type.

14. The system of claim 1, wherein the controller is further operable to provide a message to a local user about a charging status of their electronic device.

15. A method for wirelessly charging a plurality of electronic devices, the method comprising:
providing a charging station operable to wirelessly charge the plurality of electronic devices;
assigning a charging priority to each electronic device by a server based on usage information of each electronic device;
receiving the charging priority for each electronic device from the server; and
wirelessly charging the plurality of electronic devices in accordance with the charging priority of each electronic device.

16. The method of claim 15, further comprising;
registering security credentials and service profile of each electronic device within charging range of the charging station; and
transmitting the security credentials and service profile to the server, wherein
receiving includes obtaining authorization to charge the electronic device from the server based on the security credentials and service profile of the electronic device.

17. The method of claim 16, wherein charging includes adapting the operation of the charging station to charge higher priority electronic devices before lower priority electronic devices.

18. The method of claim 15, wherein charging includes limiting charging of each electronic device to a charge level sufficient for each electronic device to accomplish a task within a defined time period.

19. The method of claim 15, further comprising providing messaging regarding charging of an electronic device.

20. The method of claim 15, wherein charging includes modifying a charging profile of an electronic device based on local parameters.
